(19) United States
(12) Patent Application Publication
(10) Pub. No.: US 2001/0011122 A1
(43) Pub. Date: Aug. 2, 2001

(54) Crystallization resistant amidoamine compositions

(76) Inventors: Shailesh Shah, Dresher, PA (US); Robert M. Moon, Horsham, PA (US)

Correspondence Address: COGNIS CORPORATION, 2500 RENAISSANCE BLVD., SUITE 200, GULPH MILLS, PA, 19406

(21) Appl. No.: 09/784,905

(22) Filed: Feb. 16, 2001

Related U.S. Application Data
(62) Division of application No. 09/187,366, filed on Nov. 6, 1998.
(60) Provisional application No. 60/064,927, filed on Nov. 7, 1997.

(51) Int. Cl. C08G 59/44

(52) U.S. Cl. 528/123

(57) ABSTRACT

The invention is an amidoamine epoxy curing agent composition, which comprises the reaction product of at least one aliphatic monobasic carboxylic acid, triethylenetetraamine, and an amine selected from the group consisting of polyethylenepolyamines higher than triethylenetetraamine, cycloaliphatic amines, and mixtures thereof, its method of use, and cured epoxy compositions made from it.

### CROSS-REFERENCE TO RELATED APPLICATIONS

This application claims priority of copending provisional application U.S. 60/064,927 filed Nov. 7, 1997, the disclosure of which is hereby incorporated by reference.

### STATEMENT REGARDING FEDERALLY SPONSORED RESEARCH OR DEVELOPMENT

Not applicable.

### FIELD OF THE INVENTION

This invention relates to amidoamine compositions and their uses, including as epoxy curing agents.

### BACKGROUND OF THE INVENTION

Amine functional epoxy curing agents made by condensing fatty acids and various amines are well known in the art and are described in U.S. Pat. Nos. 2,705,223, 2,811,495, and 2,899,397, the disclosures of which are hereby incorporated by reference. Other polyamine-epoxy adducts useful as curing agents are described in U.S. Pat. Nos. 2,651,589, 2,864,775, and 4,116,900, the disclosures of which also are hereby incorporated by reference. Lower viscosity, amidoamine resins have conventionally been made primarily from blends of monomeric and dimeric fatty acids and commercial tetraethylenepentamine (TEPA). Commercially available products of this type are Genamid® 747 and Genamid® 151 by Henkel Corp., Gulph Mills, Pa.

Amidoamines made solely from triethylenetetraamine (TETA) as the amine component are subject to partial to complete crystallization or solidification (“titer”). To prevent such crystallization of these amidoamines, a significant amount of dimeric fatty acid must be included, and/or high levels of imidazoline rings must be formed. High levels of dimer acid can unacceptably increase viscosity of the amidoamines; high levels of imidazoline rings slow their reactivity. Nevertheless, amidoamine curing agents based on TETA are more desirable because TETA is a low cost amine compared to TEPA. Attempts to prepare epoxy curing amidoamines using TETA have required the use of significant levels of dimer acid with tall oil fatty acid (TOFA) and/or high imidazoline/amido amine (“IA/AA”) ratio, which either gives high viscosity or low reactivity respectively.

### SUMMARY OF THE INVENTION

The present invention overcomes the limitations of the prior art by enabling the preparation of crystallization or solidification resistant amidoamines based on TETA that exhibit high reactivity with epoxies while remaining a liquid of acceptable viscosity at ambient temperatures.

The invention relates to amidoamine compositions, which comprise the reaction product of at least one aliphatic monobasic carboxylic acid, triethylenetetraamine and an amine selected from the group consisting of homologs of polyethylenepolyamines higher than triethylenetetraamine, cyclic polyamines, and mixtures thereof, their method of use, and cured epoxy compositions made with them.

Within these formulations, the inclusion of sufficient levels of cyclic polyamines or higher homologs of polyethylenepolyamines allows the formulation of amidoamine resins with low levels of imidazole. This allows for complete reactivity with the epoxy resins while providing liquidity and excellent storage stability of the amidoamine curing composition at room temperature.

While not wishing to be bound by theory, it is believed that the crystalline impurities of TETA-based amidoamines are effectively eliminated with the incorporation of cyclic polyamines or of TEPA or PEHA and higher homologs because of the molecular features they introduce to the amidoamine structure. The result is low cost amidoamines that have reactivities comparable to commercially available amidoamines prepared by reacting TOFA and TEPA.

### DETAILED DESCRIPTION OF THE INVENTION

Except in the claims and the operating examples, or where expressly indicated, all numerical quantities in this description indicating amounts of material or conditions of reaction and/or use are to be understood as modified by the word “about” in describing the broadest scope of invention. Practice within the numerical limits stated is generally preferred. Also, unless expressly stated to the contrary: percent, “parts of”, and ratio values are by weight; the term “polymer” includes oligomer; the description of a group or class of materials as suitable or preferred for a given purpose in connection with the invention implies that mixtures of any two or more of the members of the group or class are equally suitable or preferred; description of constituents in chemical mixtures or combinations refers to the constituents at the time of addition to any mixture or combination specified in the description, and does not necessarily preclude chemical interactions among the constituents of a mixture or combination once mixed or combined.

The subject of the invention is the reaction product of preferably from about 35% to about 65%, by weight, of an aliphatic monobasic carboxylic acid, preferably from about 15% to about 30%, by weight, of tetraethylenetetraamine, and preferably from about 5% to about 25% of cyclic polyamines or polyethylenepolyamine homologs higher than tetraethylenetetramine, or mixtures thereof.

Aliphatic monobasic carboxylic acids suitable for the present invention include vegetable oil fatty acids, tall oil fatty acids, and mixtures thereof. For a general description of suitable fatty acids, see U.S. Pat. No. 3,870,666, the disclosure of which is incorporated by reference. It is preferred to have an initial (pre-reaction) weight percentage of the monobasic carboxylic acid of from 35% to 65%, preferably 40% to 55%, and more preferably 45% to 50%, of the total weight of the reactants. Preferably, the aliphatic monobasic carboxylic acid is a C₁₆ to C₁₈ acid derived from tall oil or vegetable oil, such as oleic acid, linoleic acid, linolenic acid, and the like.

Preferably, the amidoamines of the invention are formed with, in addition to the aliphatic monobasic carboxylic acid, an aliphatic polybasic carboxylic acid. Suitable aliphatic polybasic carboxylic acids are exemplified by commercial blends of dimerized fatty acids prepared by dimerizing unsaturated monocarboxylic acids derived from tall oil or vegetable oil. One such blend is sold under the tradename Empol™ 1020 by the Henkel Corporation of Gulph Mills, Pa. Preferred tall oil fatty acids for present purposes are commercially available tall oil fatty acid consisting primarily of straight-chained C₁₈ monobasic carboxylic acids with less than 2.5% by weight of unsaponifiables. Exemplary of these commercially available TOFAS is Actinol FA-2, sold by Arizona Chemical Co., which is described by the manufacturer as containing 97.8% fatty acids (37% non-conjugated linoleic, 7% conjugated linoleic, 50% oleic, 2% saturated fatty acids, and 4% other fatty acids). When the aliphatic monobasic carboxylic acid is used in conjunction with an aliphatic polybasic carboxylic acid, the preferred amount of the latter is from 5% to 30%, more preferably 10% to 20%, of the total weight of reactants.

The next reactant for preparing the amidoamine compositions of the present invention is triethylenetraamine (“TETA”). The preferred amount of TETA is from 15% to 30%, more preferably 20% to 25%, of the total weight of reactants. The preferred triethylenetetraamine used is a technical or industrial grade. Those skilled in the art will understand that commercial materials as supplied will contain higher polyethylenepolyamines and cyclics as unavoidable impurities, which do not materially alter the basic properties of the triethylenetetraamine for purposes of the present invention.

The third reactant is an amine selected from the group consisting of polyethylenepolyamine homologs higher than triethylenetetraamine, cyclic polyamines, or mixtures thereof. This component is preferably present in the amount of 5% to 25%, more preferably 7.5% to 20%, and even more preferably between 10% to 15% by weight initial concentration of reactants.

The required polyethylenepolyamine is a homolog higher than triethylenetetraamine, such as tetraethylenepentamine and pentaethylenehexamine. While all higher homologs of triethylenetetraamine, and mixtures thereof can be used, the homolog or mixture of homologs chosen should enable fast cure-times while the curing agent remains a liquid of acceptable viscosity at ambient temperatures. Suitable homologs are of the form H₂N—(CH₂—CH₂—NH)ₙ—CH₂—CH₂—NH₂, where n>2. Accordingly, the homologs of triethylenetetraamine are in a series which varies by a single —(CH₂—CH₂—NH)— group. Preferably, n will be greater than two and less than or equal to six. Exemplary of suitable amines of this type is EA-275 sold by the Dow Chemical Company of Freeport, Tex.

The amines suitable for the present invention include cyclic polyamines that can be used in conjunction with or in lieu of the aforementioned polyethylenepolyamine homologs. The concentrations of the cyclic polyamines are similar to those mentioned for the polyethylenepolyamines.

Suitable cyclic polyamines for the present invention include aliphatic or aromatic cyclic or heterocyclic polyamines having 2 to 20 carbon atoms. Among cycloaliphatic polyamines, diamino or higher polyamino derivatives of cycloaliphatic compounds, such as cyclopentane, cyclopentene, cyclohexane, cyclohexene, cycloheptane, cycloheptene, are suitable. Among heterocyclic compounds, diamino or higher polyamino derivatives, including those having primary or secondary amines incorporated into the ring structure, are also suitable. Examples of such heterocyclic amines include diamino or higher polyamino pyrrolidine, pyrroline, imidazolidine, imidazoline, pyrazolidine, pyrazoline, piperidine, piperazine, indoline, isoindoline, and the like.

Preferred among cyclic polyamines known to those skilled in the art are diaminocyclohexane, isophoronediamine, metaxylenediamine, 1,3-bis aminocyclohexane, norbornanediamine, bis(p-aminocyclohexyl)methane and aminoethylpiperaizine (“AEP”). Other suitable amines include phenylene diamine, methylene dianiline, and diamino benzene. As well, those skilled in the art may identify other amines having a cyclic structure within the molecule that exhibit a degree of cross-linking and molecular weight which makes them suitable for use within the present invention.

The amidoamines of the present invention can be prepared by methods known per se to those skilled in the art. See, for example, U.S. Pat. Nos. 2,705,223, 2,811,495, and 2,899,397. Typically, the reactants are charged into a suitable reaction vessel and reacted at a temperature of 150° C. to 240° C. for about ten minutes to several hours. In a preferred embodiment, the reactor is provided with one or more condensers to remove the water of reaction, which can quench or reverse the progress of the reaction.

In another preferred aspect, the reaction is carried out, at least partially, under a vacuum, preferably 25 to 75 mm Hg, more preferably about 50 mm Hg. The purpose of the vacuum is to promote formation of imidazoline rings by removing the water of reaction. Preferably, the ratio IA/AA in the final amidoamine is 0.5 to 2.0, more preferably about 1.0 to 1.5. This ratio can be determined by methods also known per se to the skilled artisan, for example by Fourier Transfer Infrared Spectroscopy. Alternatively, the desired removal of water and resultant IA/AA ratio can be achieved by running the reaction at higher temperatures, but this can produce undesirable by-product formation with resultant unsuitability for certain applications where product color, clarity and odor are important factors.

Too high a temperature in the vessel must be avoided so that the amine, which has a very low viscosity, does not overflow into the reactor's condensor. Since the objective of the present invention is to provide an epoxy curing agent that exhibits excellent physical properties (e.g., low viscosity at ambient temperatures) while maintaining high reactivity with epoxies and short cure-time, the reaction should be monitored closely, based on the IA/AA ratio. Ratios that are too high will result in curing agents with undesirably long cure-times, while ratios that are too low will yield a curing agent with poor reactivity.

### Epoxy Resins

The curing agents of the present invention are intended for use in combination with epoxy resins to make bulk castings, potting materials, structural adhesives, coatings, mortars, and grouts and the like.

An epoxy resin composition of the present invention may further contain additives conventionally employed in epoxy technology, such as organic pigments, inorganic pigments, surfactants, thickeners, and the like.

The amount of epoxy resin which is present in the epoxy composition is preferably sufficient to achieve substantially stoichiometric equivalence with the reactive amino hydrogens on the end capped epoxy-amine adduct. In general, it is preferred to employ the epoxy resin in an amount sufficient to achieve an epoxy to reactive amine hydrogen equivalent weight ratio of from 0.5:1.0 to 1.5:1.0 and, preferably, from 0.8:1.0 to 1.2:1.0.

The epoxy resins which are useful herein, may be either liquids or solids.

Epoxies, including those listed below, would be used at one epoxide equivalent weight of epoxy to one amine hydrogen equivalent weight of the amidoamine curing agents of the invention. The epoxy resins used in the practice of this invention comprise one or more polyglycidyl ethers of aliphatic or aromatic alcohols having one or more epoxide groups in the molecule, as represented by the structural formula:

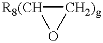

wherein

R₈ represents a ‘g’ valent C₆-C₅₀ organic comprising at least one ring (e.g. when g is 1-6, R₈ can be —CH₂—O—φ—C(CH₃)₂—φ—O—CH₂— or R8 can be —CH₂—O—φ—CH₂—φ—O—CH₂— wherein φ represents a phenyl group).

Techniques to prepare such epoxy resins are known in the art, and include reacting compounds having 2 or more hydroxyl groups with epichlorohydrin in the presence of a suitable catalyst. Suitable epoxy resins are commercially available from a variety of sources and include EPON (Reg. TM) epoxy resins from Shell Chemical Company, Houston, Tex., and DER (Reg. TM) or DEN (Reg. TM) epoxy resins from Dow Chemical Company, Midland, Mich.

Examples of suitable epoxy resins are:

I) Polyglycidyl and poly(beta-methylglycidyl) esters obtainable by reacting a compound having at least two carboxy groups in the molecule with epichlorohydrin or beta-methyl-epichlorohydrin, respectively. The reaction is advantageously carried out in the presence of bases. Examples of aromatic polycarboxylic acids which may be used include, for example, phthalic acid, isophthalic acid or terephthalic acid.

II) Polyglycidyl or poly(beta-methylglycidyl) ethers obtainable by reacting a compound having at least two free phenolic hydroxy groups with epichlorohydrin or beta-methyl-epichlorohydrin, respectively, under alkaline conditions, or in the presence of an acid catalyst and with subsequent alkali treatment.

The epoxy compounds of this type may be derived from mononuclear phenols, such as, for example, resorcinol or hydroquinone; or they are based on polynuclear phenols, such as, for example, bis(4-hydroxyphenyl)methane, 4,4′-dihydroxybiphenyl, bis(4-hydroxyphenyl)sulfone, 1,1,2,2-tetrakis(4-hydroxyphenyl)ethane, 2,2-bis(4-hydroxyphenyl)propane, 2,2-bis(3,5-dibromo-4-hydroxyphenyl) propane, and from novolacs obtainable by condensation of aldehydes, such as formaldehyde, acetaldehyde, chloral or furfuraldehyde, with phenols, such as phenol, or with phenols that are substituted in the nucleus by halide atoms or C₁-C₁₈ (preferably C₁-C₉) alkyl groups, such as, for example, 4-chlorophenol, 2-methylphenol or 4-tertbutylphenol, or by condensation with bisphenols, in the manner described above.

There are preferably used epoxy resins that have an epoxy content of from 2 to 10 equivalents/mole and that are glycidyl ethers or glycidyl esters of aromatic or alkylaromatic compounds. Especially preferred epoxy resins are polyglycidyl ethers of bisphenols, such as, for example, of 2,2-bis(4-hydroxyphenyl)propane (bisphenol A) or bis(4-hydroxyphenyl)methane (bisphenol F), or novolacs formed by reacting formaldehyde with a phenol. For reasons of cost and availability, the most preferred epoxy resins are polyglycidyl ethers based on bisphenol A.

Preferred epoxy resins have an epoxide equivalent weight of less than about 400 grams/equivalent, e.g. from about 100 grams/equivalent to about 350 grams/equivalent, more preferably from about 150 grams/equivalent to about 225 grams/equivalent, e.g. DER 331 available from Dow Chemical at about 182 grams/equivalent. Unless otherwise indicated, DER 331 is the epoxy resin used in the examples below

Also useful, when high resistance to ultraviolet light (UV) is desired, are the hydrogenated bisphenol A diglycidyl ethers, an example of which is Eponex 1510 (TM Shell Chemical Co.), or aliphatic polyglycidyl ethers, an example of which is trimethylol propane triglycidyl ether, sold as GE-30 (CVC Specialties) and as Heloxy Modifier 48 (TM Shell Chemical Co.).

Additives to bulk epoxy systems that can be made from the curing agents of the invention and neat epoxy resins are many; among them are colorants, fillers, reinforcements, coupling agents, flexibilizers, diluents, flame retardants, rheology modifiers, release agents and the like.

The epoxy curing agents of the present invention are used in combination with curing agents of the present invention. Generally, a suitable polyamine curing agents is that which contains more than 2 active hydrogen atoms per molecule. Examples of such curing agents are alkylene polyamines represented by the formula H₂N—T—(NH—T)ᵤNH₂, wherein ‘T’ is an alkylene radical containing 2 to 8 carbon atoms and ‘u’ is equal to or greater than zero (0) but less than or equal to five (5). Such alkylene polyamines include ethylenediamine, diethylenetriamine, triethylenetetramine, tetraethylenepentamine, pentaethylenehexamine, propylenediamine, dibutylenetriamine, hexamethylenediamine and their ethoxylated and propoxylated adducts and the like. Included, also, among usable co-curing agents are aminoethylpiperazine, 2-methylpentanediamine, polyethyleneimine and cycloaliphatic amines. Optional additional curing agents are polyalkyleneoxide amines such as polyethylene oxide amines like triethyleneglycol diamine, polyethyleneoxide-co-propylene oxide amines and lower molecular weight polypropyleneoxide di- and tri-amines, dimerized fatty diamine, and amine-terminated polybutadiene.

A cure accelerator may also be added. Commercially available cure accelerators or catalysts that may be used include 2,4,6 tri(dimethylaminomethyl) phenol, dimethylaminomethylphenol, benzyldimethylamine, pyridine, triethylamine, triethylene diamine and the like. They are typically used at levels ranging from 0.5 wt. % to 10 wt. %.

The following examples serve to further illustrate the invention, but should not be construed to limit the invention, unless expressly set forth in the appended claims. The reactants and other specific ingredients presented are typical, and various modifications can be made in view of the foregoing disclosure within the scope of the invention. All parts, percentages, and ratios are by weight unless otherwise indicated in context.

While the present invention has been described above in the context of its use as an epoxy curing agent, it will be understood by those of ordinary skill in the art that the polyamidoamine of the present invention find use in all fields in which polyamidoamines typically find utility, such as, for example, bore-hole additives for the drilling industry, and the like, and that nothing in the description or claims is intended to limit the utility of the claimed compositions as such.

### EXAMPLES

The amidoamine compositions in the following examples were prepared using a 1000 ml 4-neck glass reaction flask provided with a 500 mm Allihn condenser, a nitrogen feed, and a temperature probe. The Allihn condenser was connected in series to a 330 mm Friedrichs condenser, which in turn was provided with a vacuum receiver flask. Vacuum for the system was drawn by a vacuum pump through a fitting between the Friedrichs condenser and the receiver flask.

The reactions were carried out as follows: the reactants were weighed and introduced into the reactor; the reactor contents were heated to the desired temperature, typically at least about two hours or more; a vacuum was drawn in the reactor to approximately 50 mm Hg and held for 15 minutes, when the vacuum was broken with nitrogen. The IA/AA ratio was checked using Fourier Transfer Infrared Spectroscopy with a Mattson Instruments Galaxy Series FT-IR spectrometer. The ratio was determined by comparing peak heights at 1658 mm (AA) and 1614 mm (IA). If the IA/AA ratio was lower than desired, the reactor was heated again and the contents held for another 15 minutes under vacuum before rechecking. If the IA/AA was higher than desired, water was added to reduce the IA content. The solution was then held for about 5 minutes before rechecking. Once the desired IA/AA ratio was achieved, the vessel was cooled to about 60° C. and discharged.

### Example 1

| | Wt. Ratio | Wt. % | g |
|---|---|---|---|
| TOFA | 70 | 41.11 | 1315.5 |
| Empol ™ 1020 | 30 | 17.62 | 563.8 |
| TETA | 39.375 | 23.12 | 739.8 |
| AEP | 30.913 | 18.15 | 580.8 |
| | 170.288 | 100 | 3199.9 |

The ingredients were weighed into the reactor and heated to 200° C. (392° F.). Upon reaching 200° C., a vacuum was pulled to 50 mm Hg and held 15 minutes. The vacuum was broken with nitrogen, and the IA/AA ratio was checked and adjusted as needed to meet the target value of 0.5. See Table 1 for the properties of the resulting curing agent.

### Example 2

| | Wt. Ratio | Wt. % | g |
|---|---|---|---|
| TOFA | 75 | 48.04 | 288.2 |
| Empol ™ 1020 | 25 | 16.01 | 96.1 |
| TETA | 39.375 | 25.22 | 151.3 |
| TEPA | 16.75 | 10.73 | 64.4 |
| | 156.125 | 100 | 600 |

The reaction procedure was the same as that in Example 1, except the charge was heated to 204° C. and the target IA/AA ratio was 1.5. See Table 1 for the properties of the resulting curing agent.

### Example 3

| | Wt. Ratio | Wt. % | g |
|---|---|---|---|
| TOFA | 75 | 44.04 | 264.2 |
| Empol ™ 1020 | 25 | 14.68 | 88.1 |
| TETA | 39.375 | 23.12 | 138.7 |
| AEP | 30.913 | 18.16 | 109.0 |
| | 170.288 | 100 | 600 |

The reaction procedure was the same as that in Example 2. See Table 1 for the properties of the resulting curing agent.

### Example 4

The reaction procedure was the same as that in Example 2 and the formula was the same as in example 1; 600 g made. See Table 1 for the properties of the resulting curing agent.

| | G-747 | Example 2 | Example 4 |
|---|---|---|---|
| Feel | very sticky | sticky | not sticky |

### Example 5

Formula from example 1; 1200 grams made for testing. Initial heating was 195° C. Times and temperatures to establish the desired IA/AA value are given below:

| | Timed vacuum | Temp. | IA/AA |
|---|---|---|---|
| | sessions (min) | started ° C. | after vacuum |
| 1 | 15 | 195 | 0.33 |
| 2 | 20 | 195 | 0.66 |
| 3 | 15 | 195 | 0.77 |
| 4 | 15 | 195 | 0.87 |
| 5 | 15 | 200 | 0.90 |
| 6 | 15 | 204 | 0.95 |
| 7 | 5 | 204 | 1.02 |

See Table 1 for the properties of the resulting curing agent.

### Example 6

Formula from example 2; 1200 g made for testing.

| | Timed vacuum | Temp. | IA/AA |
|---|---|---|---|
| | sessions (min) | started ° C. | after vacuum |
| 1 | 15 | 204 | 0.82 |
| 2 | 15 | 204 | 1.40 |
| 3 | 5 | 204 | 1.52 |

See Table 1 for the properties of the resulting curing agent.

### Example 7

Formula from example 6; adjusted for a lower IA/AA ratio. Approximately 400 g of the amidoamine example 6 was heated to 175° C. and water was added to bring the IA/AA ratio to 1.0.

| | IA/AA | Visc |
|---|---|---|
| initially | 1.35 | |
| add 0.5 g H₂O | 1.14 | |
| add 0.5 g H₂O | 1.00 | 4.7 |

See Table 1 for the properties of the resulting curing agent.

### Example 8

Formula from Example 5; adjusted for a lower IA/AA ratio. Approximately 400 g of Example 5 was heated to 175° C. and water was added to bring its IA/AA ratio to 0.5.

| | IA/AA | Visc. |
|---|---|---|
| initially | 0.94 | 2.93 |
| add 0.5 g H₂O | 0.83 | |
| add 0.5 g H₂O | 0.77 | |
| add 0.5 g H₂O | 0.69 | |
| add 0.75 g H₂O | 0.60 | |
| add 0.75 g H₂O | 0.52 | 3.7 |

### Example 9

| | Wt. Ratio | Wt. % | g |
|---|---|---|---|
| TOFA | 90 | 55.86 | 446.9 |
| Empol ™ 1020 | 10 | 6.20 | 49.7 |
| TETA | 34.23 | 21.25 | 170.0 |
| AEP | 26.89 | 16.69 | 133.5 |
| | 161.12 | 100 | 800.1 |

The reaction procedure was the same as that in Example 1. See Table 1 for the properties of the resulting curing agent.

### Example 10

| | Wt. Ratio | Wt. % | g |
|---|---|---|---|
| TOFA | 80 | 49.65 | 297.9 |
| Empol ™ 1020 | 20 | 12.41 | 74.5 |
| TETA | 34.23 | 21.25 | 127.5 |
| AEP | 26.89 | 16.69 | 100.1 |
| | 161.12 | 100.00 | 600 |

The reaction procedure was the same as that in Example 1, except the charge was discharged at 100° C. See Table 1 for the properties of the resulting curing agent.

### Example 11

| | Wt. Ratio | Wt. % | g |
|---|---|---|---|
| TOFA | 80 | 46.98 | 281.9 |
| Empol ™ 1020 | 20 | 11.74 | 70.5 |
| TETA | 39.375 | 23.12 | 138.7 |
| AEP | 30.913 | 18.15 | 108.9 |
| | 170.288 | 99.99 | 600 |

The reaction procedure was the same as that in Example 1, except the vacuum was pulled to 75 mm Hg (27″). See Table 1 for the properties of the resulting curing agent.

### Example 12

The reaction procedure and formula were both the same as in Example 1. See Table 1 for the properties of the resulting curing agent.

### Example 13

The reaction procedure and formula were both the same as in Example 1, but with a target IA/AA of 1; 700 g made.

### Example 14

The reaction procedure and formula were both same as in Example 2. See Table 1 for the properties of the resulting curing agent.

### Example 15

| | Wt. Ratio | Wt. % | g |
|---|---|---|---|
| TOFA | 70 | 43.62 | 261.7 |
| Empol ™ 1020 | 30 | 18.69 | 112.2 |
| TETA | 39.375 | 24.53 | 147.2 |
| EA-275 | 21.12 | 13.16 | 79.0 |
| | 160.495 | 100 | 600.1 |

The reaction procedure was the same as in Example 2, except the target IA/AA was 1. See Table 1 for the properties of the resulting curing agent.

### Example 16

| | Wt. Ratio | Wt. % | g |
|---|---|---|---|
| TOFA | 75 | 45.90 | 1469 |
| Empol ™ 1020 | 25 | 15.30 | 490 |
| TETA | 39.375 | 24.10 | 771 |
| EA-275 | 24.02 | 14.70 | 470 |
| | 163.395 | 100 | 3200 |

The reaction procedure was the same as in Example 2, except the target IA/AA was 1. See Table 1 for the properties of the resulting curing agent.

### Example 17

Same procedure and formula as in Example 2, except the target IA/AA was 1. See Table 1 for the properties of the resulting curing agent.

### Example 18

| | Wt. Ratio | Wt. % | g |
|---|---|---|---|
| TOFA | 70 | 43.62 | 261.7 |
| Empol ™ 1020 | 30 | 18.69 | 112.2 |
| TETA | 39.375 | 24.53 | 147.2 |
| TEPA | 21.12 | 13.16 | 79.0 |
| | 160.495 | 100 | 600.1 |

Same procedure as in Example 2 except the target IA/AA ratio was 1. See Table 1 for the properties of the resulting curing agent.

### Example 19

| | Wt. Ratio | Wt. % |
|---|---|---|
| TOFA | 70 | 41.1 |
| Empol ™ 1020 | 30 | 17.6 |
| TETA | 39.375 | 23.1 |
| AEP | 21.12 | 18.1 |

Same procedure as in Example 1, except the target IA/AA ratio was 1. See Table 1 for the properties of the resulting curing agent.

### Example 20

| | Tack-free time (minutes) |
|---|---|
| Example 15 | 109.48 |
| Example 14 | 113.31 |
| Genamid 747 | 109.29 |
| Genamid 151 | 92.47 |
| Example 13 | 42.24 |
| Example 19 | 62.2 |

### Example 21

Same procedure and formula as in Example 1; 1600 g made. See Table 1 for the properties of the resulting curing agent.

### Example 22

Same procedure as in Example 1. See Table 1 for the properties of the resulting curing agent.

### Example 23

Same procedure as in Example 1, same formula as example 16, target IA/AA of 1. See Table 1 for the properties of the resulting curing agent.

### Example 24

The curing agents of the present invention were compared to commercially available agents in terms of cured epoxy coating performance. 100 parts of liquid epoxy (bispheral A diglycidyl ether, DER-331 from Dow Chemical, Freeport, Tex.) with 50 parts curing agent. The results are summarized in Table 2. As can be seen, the performance of cured epoxy coatings made with the amidoamines of the present invention compare favorably to coatings prepared with the TEPA-based industry standard curing agents.

The principles, preferred embodiments and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

TABLE 1

| EXAM- | | | | | | | | | | | | | | | | |
|---|---|---|---|---|---|---|---|---|---|---|---|---|---|---|---|---|
| PLE | 1 | 2 | 3 | 4 | 5 | 6 | 7 | 8 | 9 | 10 | 11 | 12 | 13 | 14 | 15 | 16 |
| IA/AA | 0.529 | 1.45 | 1.05 | 0.98 | 1.02 | 1.52 | 1.00 | 0.52 | 0.537 | 0.556 | 0.53 | 0.463 | 0.989 | 1.03 | 1.02 | 0.994 |
| Clarity | clear, | clear, | slight | clear, | clear, | clear, | some | | titer | titer | clear, | clear | clear | clear, | clear, | clear, |
| | no haze | no haze | titer | no haze | no haze | no haze | titer | | in 3 | in 5 | no | | | no | no | no |
| | or titer | | | or titer | or titer | or titer | after | | days | days | haze | | | haze | haze | haze |
| | | | | | | | 9 mos. | | | | or titer | | | or titer | or titer | or titer |
| Color | 7-8 | 9, | 11, | 9, | 8, | 8 | 8 | 8 | 7-8 | 6 | 8-9 | 6 | 6-7 | 6-7 | 5-6 | 5-6 |
| (Gardner) | | slight | slight | no | no | | | | | | | | | | | |
| | | green | green | green | green | | | | | | | | | | | |
| Amine | 473 | 405 | 407 | 454 | 450 | 396 | 396 | 450 | 380 | 378 | 430 | 470 | 473.8 | 411 | 435 | 453 |
| Value | | | | | | | | | | | | | | | | |
| Viscosity | 3.2 | 4.38 | 3.5 | 3 | 2.53 | 3.95 | 4.7 | 3.7 | 2.475 | 3.45 | 2.73 | 3.22 | 2.31 | 5.55 | 6.125 | 4.65 |
| (Poise) | | | | | | | | | | | | | | | | |
| (Note 1) | | | | | | | | | | | | | | | | |
| Gel Time | 41′03″ | 145′5″ | | 93′27″ | | | | | | | | | 61.3′ | 113′31″ | 109′48″ | 92′19″ |
| Tack Free | 5.38- | 13 | | 12.5 | | | | | | | | | | 8.75 | 7.375 | |
| Time (hrs) | 7.09 | | | | | | | | | | | | | | | |

| EXAMPLE | 17 | 18 | 19 | 21 | 22 | 23 | Genamid 151 | Genamid 747 |
|---|---|---|---|---|---|---|---|---|
| IA/AA | 1.03 | 1.02 | 1.01 | .458 | .492 | .994 | 0.9 | 1.5 |
| Clarity | clear | clear | | clear | clear | clear | clear | clear |
| Color (Gardner) | 6-7 | 5-6 | ˜6 | 8-9 | 5-6 | 5-6 | 7 | 7 |
| Amine Value | 411 | 435 | 453 | 464.2 | 472.9 | 453 | 425-450 | 450-475 |
| Viscosity (Poise) | 5.55 | 6.125 | 2.9 | 3.25 | 3.1 | 4.65 | 2.3-4.0 | 2-5 |
| (Note 1) | | | | | | | | |
| Gel Time | 113′31″ | 109′48″ | | | | 92′19″ | 86′16″-96′12″ | 88′24″-109′29″ |
| Tack Free Time | | | | | | 6.44″ | 96′12″ | 6.81-7.23 |
| (hrs) | | | | | | | | |

(Note 1)
As measured on a Brookfield DV-1 thermocell viscometer, 25° C., no. 21 spindle.

TABLE 2

| | TENSILE | | TENSILE | FLEXURAL | FLEX | COMPRESSIVE | COMPRESSIVE |
|---|---|---|---|---|---|---|---|
| | STRENGTH | % TENSILE | MODULUS | STRENGTH | MODULUS | STRENGTH | MODULUS |
| SAMPLE | (PSI) | ELONGATION | (PSI) | (PSI) | (PSI) | PSI | PSI |
| Genamid 747 | 5550 | 3.5 | 208300 | 12160 | 389000 | 10910 | 231100 |
| Genamid 151 | 6440 | 5 | 181300 | 12200 | 360200 | 11200 | 238900 |
| Example 1 | 6300 | 4 | 179100 | 13220 | 408400 | 12660 | 242500 |
| Example 19 | 5680 | 3.5 | 210400 | 12720 | 413700 | 12180 | 240000 |
| Example 14 | 5540 | 3.7 | 192000 | 12020 | 338700 | 11260 | 232100 |
| Example 15 | 6020 | 3.8 | 198300 | 12290 | 393800 | 11770 | 243900 |

What is claimed is:

1. An amidoamine composition comprising the reaction product of:
an aliphatic monobasic carboxylic acid;
triethylenetetraamine; and
an amine selected from the group consisting of polyethylenepolyamines of the formula H₂N—(CH₂—CH₂—NH)ₙ—CH₂—CH₂—NH₂ where n>2, aliphatic or aromatic cyclic or heterocyclic polyamines having 2 to 20 carbon atoms, and mixtures thereof.

2. An amidoamine composition according to claim 1, wherein the aliphatic monobasic carboxylic acid is a vegetable oil fatty acid, a tall oil fatty acid, or a mixture thereof.

3. An amidoamine composition according to claim 1, wherein 2<n≦6.

4. An amidoamine composition according to claim 3, wherein the amine is pentaethylenehexamine, tetraethylenepentamine, or a mixture thereof.

5. An amidoamine composition according to claim 1, wherein the amine is selected from the group consisting of diaminocyclohexane, isophoronediamine, metaxylenediamine, 1,3-bis aminocyclohexane, norbornanediamine, bis(p-aminocyclohexyl)methane, and aminoethylpiperazine.

6. An amidoamine composition according to claim 1, further comprising an aliphatic polybasic carboxylic acid.

7. An amidoamine composition according to claim 6, wherein the aliphatic polybasic carboxylic acid is a dimerized fatty acid, a trimerized fatty acid, or a mixture thereof.

8. An amidoamine composition according to claim 7, wherein the aliphatic monobasic carboxylic acid is a vegetable oil fatty acid and the aliphatic polybasic carboxylic acid is a dimerized vegetable oil fatty acid.

9. An amidoamine composition comprising the reaction product of reactants consisting essentially of:
35% to 65% of an aliphatic monobasic carboxylic acid;
15% to 30% of triethylenetetraamine; and
5% to 25% of an amine selected from the group consisting of polyethylenepolyamines of the formula H₂N—(CH₂—CH₂—NH)ₙ—CH₂—CH₂—NH₂ where n>2, aliphatic or aromatic cyclic or heterocyclic polyamines having 2 to 20 carbon atoms, and mixtures thereof.

10. An amidoamine composition according to claim 9, wherein the reactants further consist essentially of 5% to 30% of an aliphatic polybasic carboxylic acid.

11. An amidoamine composition according to claim 9, wherein the reactants consist essentially of:
40% to 55% of the aliphatic monobasic carboxylic acid; and
7.5% to 20% of the amine selected from the group consisting of polyethylenepolyamines of the formula H₂N—(CH₂—CH₂—NH)ₙ—CH₂—CH₂—NH₂ where n>2, aliphatic or aromatic cyclic or heterocyclic polyamines having 2 to 20 carbon atoms, and mixtures thereof.

12. An amidoamine composition according to claim 11, wherein the reactants consist essentially of:
45% to 50% of the aliphatic monobasic carboxylic acid;
20% to 25% of triethylenetetraamine; and
10% to 15% of the amine selected from the group consisting of polyethylenepolyamines of the formula H₂N—(CH₂—CH₂—NH)ₙ—CH₂—CH₂—NH₂ where n>2, aliphatic or aromatic cyclic or heterocyclic polyamines having 2 to 20 carbon atoms, and mixtures thereof.

13. An amidoamine composition according to claim 12, wherein the reactants further consist essentially of 10% to 20% of an aliphatic polybasic carboxylic acid.

14. An amidoamine composition according to claim 19, wherein the aliphatic monobasic carboxylic acid is a vegetable oil fatty acid, a tall oil fatty acid, or a mixture thereof, wherein 2<n≦6, and wherein the cyclic polyamine is selected from the group consisting of diaminocyclohexane, isophoronediamine, metaxylenediamine, 1,3-bis aminocyclohexane, norbornanediamine, bis(p-aminocyclohexyl)methane, and aminoethylpiperazine.

15. An amidoamine composition according to claim 10, wherein the aliphatic polybasic carboxylic acid is a dimerized fatty acid, a trimerized fatty acid, or a mixture thereof.

16. A cured epoxy composition comprising an epoxy resin and an amount of the composition of claim 1 effective to harden said epoxy resin.

17. A method of curing an epoxy resin composition comprising combining an epoxy resin with the composition of claim 1 and allowing said combination to cure.

18. An amidoamine composition comprising the reaction product of:
an aliphatic monobasic carboxylic acid;
triethylenetetraamine; and
an amine selected from the group consisting of polyethylenepolyamine homologs higher than triethylenetetraamine, cyclic polyamines, and mixtures thereof.
